(19) United States
(12) Patent Application Publication
(10) Pub. No.: US 2011/0318137 A1
(43) Pub. Date: Dec. 29, 2011

(54) DRILLING FASTENER

(75) Inventor: JIN-SUN CHEN, TAINAN COUNTY 711 (TW)

(73) Assignee: ESSENCE METHOD REFINE CO., LTD., TAINAN COUNTY 711 (TW)

(21) Appl. No.: 12/832,255

(22) Filed: Jul. 8, 2010

(30) Foreign Application Priority Data
Jun. 25, 2010 (TW) 099212172

(51) Int. Cl. F16B 25/10

(52) U.S. Cl. 411/387.1

(57) ABSTRACT

A drilling fastener utilizes at least two sides jointed to form a shank. A corner point is formed between any two sides for outwardly extending a rib therefrom. The rib includes a cutting section extended outwardly from the corner point about an arc contour, and a arc section whose two sides respectively connect to the cutting section and the side. A cutting tip is formed at a convergence of the cutting section and the arc section and located at which the largest outer diameter of the shank is defined. An accommodating room is defined between each arc section and the side. Thereby, the auxiliary cutting provided by the cutting tip allows the debris to be swiftly extruded via the accommodating room, thence preferably decreasing the driving torque and preventing the workpiece from being damaged. The fixing efficiency after screwing is further promoted.

### BACKGROUND OF THE INVENTION

1. Field of the Invention

The present invention relates to a fastener, particularly to a drilling fastener that takes advantage of a rotative torque to fasten.

2. Description of the Related Art

Referring to FIGS. 1 and 2, a conventional screw 1 comprises a head 11, a shank 12 outwardly extended from the head 11, a threaded section 13 spirally arranged on the shank 12, and a drill point 14 disposed on the shank 12, opposite to the head 11. Wherein, a plurality of V-slots 121 are depressed around the circumference of the shank 12. In time of drilling, the entrance of the drill point 14 and the threaded section 13 into a workpiece (not shown) allows the V-slots 121 to grind the debris entangling on the shank 12. Moreover, the V-slots 121 further provide a space for the debris to accommodate, thereby achieving a complete fastening operation.

However, the screw 1 actually has the following shortcomings in time of the practical operation:

1. Except the V-slots 121, the shank 12 formed by a column structure still touches the workpiece 2 by a large contacting area. As a result, an enormous driving resistance is brought about.

2. In order not to lessen the strength of the shank 12, the V-slots 121 are defined somewhat shallow. Thereby, the shallow V-slots 121 neither provide an enough accommodating room for receiving debris nor timely expel the debris. Moreover, in time of drilling a harder workpiece, a great pressure is generated between the shank 12 and the workpiece due to the failure to instantly extrude the debris out. As a result, the increased drilling resistance is caused and a breakage to the workpiece is also incurred.

### SUMMARY OF THE INVENTION

It is therefore the purpose of this invention to provide a drilling fastener to enhance the debris accommodating effect and the debris extruding effect, thereby lowering the drilling torque to prevent the workpiece from breakage.

The drilling fastener in accordance with the present invention takes advantages of a head, a shank disposed on the head, and a threaded section spirally arranged on the shank. Wherein, an inclined connecting surface is disposed between the head and the shank. At least two sides are formed on a periphery of the shank; a corner point is formed by a connection of any two sides. A rib is outwardly extended from each corner point. Wherein, each rib includes a cutting section extended outwardly from the corner point about an arc contour, and an arc section whose two ends respectively connect to the cutting section and the side. Moreover, a cutting tip is formed at a convergence of the cutting section and the arc section; the cutting tip is further arranged where a largest outer diameter of the shank is defined. Concurrently, an accommodating room is defined between each arc section and the side. Thereby, the rib lessens the contacting area between the shank and the workpiece in time of cutting. By cooperating with the distinct structure of the accommodating room, effects of extruding redundant debris and accommodating the residue of debris are also promoted. Thus, the fastening speed is enhanced, the drilling torque is decreased to save users' effort, and the workpiece is prevented from damage. An outstanding fixing effect is accordingly encouraged.

Preferably, a guiding section is connectively arranged between the corner point and the cutting section; a debris-guiding room is defined at a side of the guiding section; the debris-guiding room and the accommodating room are communicated with each other.

Preferably, a guiding section is disposed between the corner point and the cutting section; a plurality of sunken slots are disposed on the cutting section.

Preferably, a plurality of cutting ribs are disposed on the connecting surface, corresponding to the rib; a cutting indentation is formed between any two of the cutting ribs.

Preferably, at least one of the sides is inwardly depressed.

Preferably, the shank is divided into a first shank and a second shank; the first shank is constructed by a column, and the second shank is constructed by at least two sides; a corner point is disposed by a connection of any two of the sides; the rib is extended from the corner point.

Preferably, the shank is formed by a first shank and a second shank; the first shank is constructed by at least two sides; a corner point is disposed by a connection of any two of the sides; the second shank is constructed by a column; the rib is extended from the corner point.

Preferably, a thread-free section is formed among the threaded section.

Preferably, the threaded section is formed by at least two cutting surfaces, and a cutting side is formed at a convergence of any two of the cutting surfaces; the corner point of the shank is correspondingly disposed to the cutting edge.

Preferably, the threaded section is formed by at least two cutting surfaces, and a cutting side is formed at a convergence of any of the two cutting surfaces; the corner point of the shank is correspondingly disposed to the cutting surface.

Preferably, the threaded section disposed with respect to the side and the arc section further includes a breach.

### BRIEF DESCRIPTION OF THE DRAWINGS

FIG. 1 is a perspective showing a conventional screw;

FIG. 2 is a cross-sectional view of FIG. 1;

FIG. 3 is a perspective view showing the a first preferred embodiment of the present invention;

FIG. 4 is a cross-sectional view showing the first preferred embodiment of the present invention;

FIG. 5 is another cross-sectional view showing the first preferred embodiment of the present invention;

FIG. 6 is another cross-sectional view showing the first preferred embodiment of the present invention;

FIG. 7 is a cross-sectional view showing section A-A of FIG. 3;

FIG. 8 is a schematic view showing the first preferred embodiment of the present invention in screwing;

FIG. 9 is a schematic view showing a second preferred embodiment;

FIG. 10 is cross-sectional view showing a third preferred embodiment of the present invention;

FIG. 11 is a partial perspective view showing the third preferred embodiment of the present invention;

FIG. 12 is another perspective view showing the third preferred embodiment of the present invention;

FIG. 13 is a cross-sectional view showing a fourth preferred embodiment of the present invention;

FIG. 14 is a perspective view showing a fifth preferred embodiment of the present invention;

FIG. 15 is a top view showing section B-B in FIG. 14;

FIG. 16 is a perspective view showing a sixth preferred embodiment of the present invention;

FIG. 17 is another perspective view showing the sixth preferred embodiment of the present invention;

FIG. 18 is a perspective view showing a seventh preferred embodiment of the present invention;

FIG. 19 is a perspective view showing an eighth preferred embodiment of the present invention;

FIG. 20 is a perspective view showing a ninth preferred embodiment of the present invention;

FIG. 21 is a cross-sectional view showing section C-C in FIG. 20;

FIG. 22 is a cross-sectional view showing the ninth preferred embodiment of the present invention;

FIG. 23 is another cross-sectional view showing the ninth preferred embodiment of the present invention;

FIG. 24 is a perspective view showing a tenth preferred embodiment of the present invention;

FIG. 25 is a cross-sectional view showing section D-D in FIG. 24.

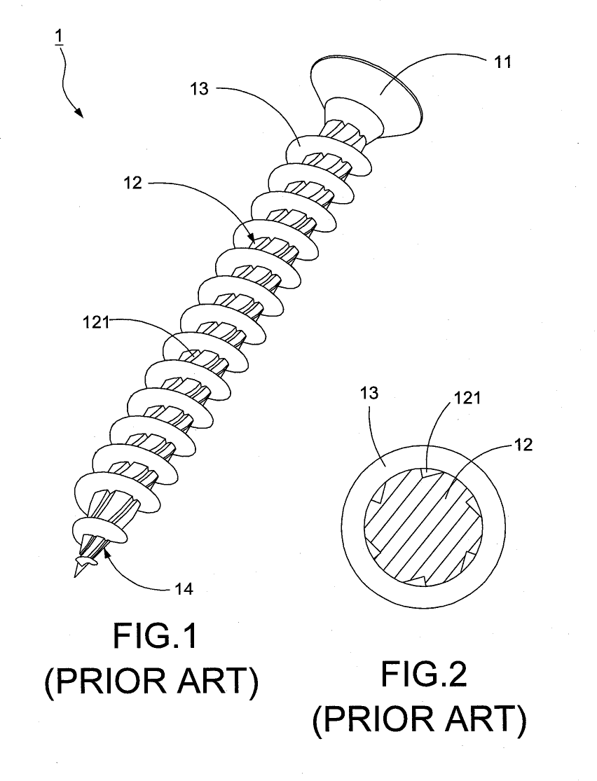

### DETAILED DESCRIPTION OF THE PREFERRED EMBODIMENTS

Wherever possible, the same reference numbers are used in the drawings and the description to refer to the same or like parts.

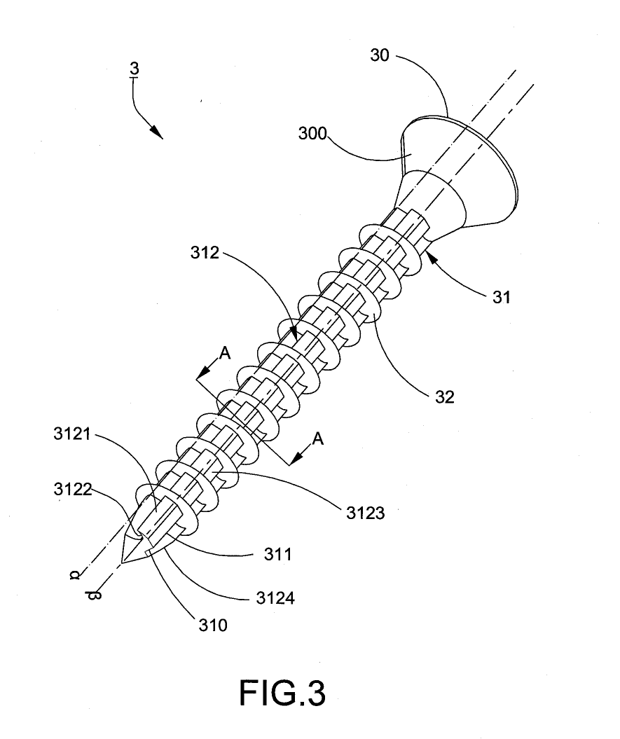

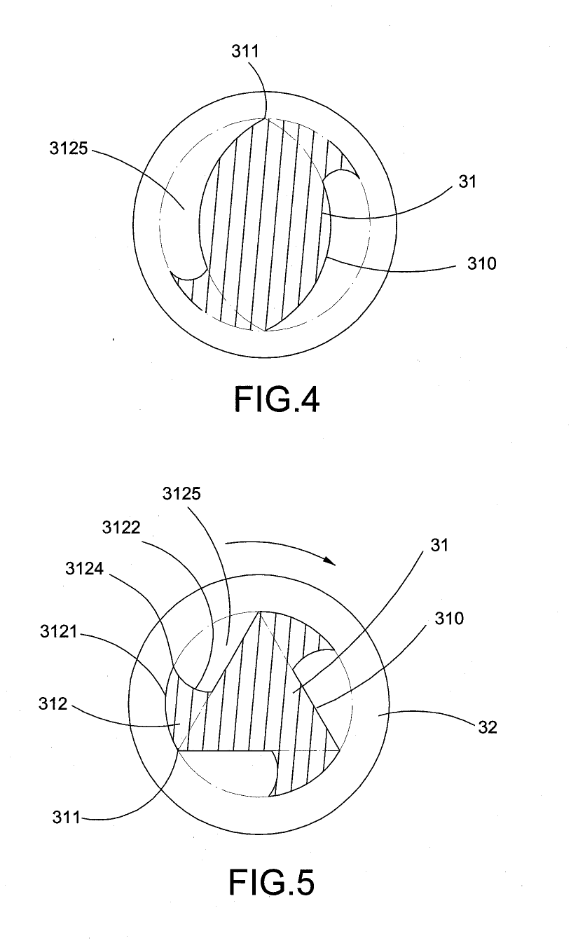

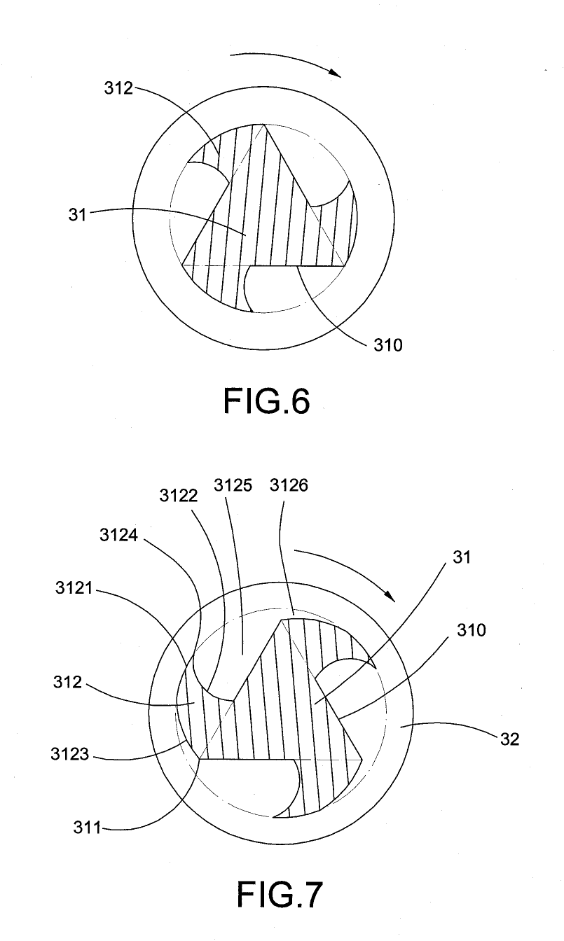

Referring to FIG. 3, a first preferred embodiment of the present invention is shown. A screw 3 comprises ahead 30, a shank 31 disposed on the head 30, and a threaded section 32 spirally arranged on the shank 31. Wherein, an inclined connecting surface 300 is disposed between the head 30 and the shank 31. At least two sides 310 are formed on a periphery of the shank, like the one shown in FIG. 4. Preferably, three sides 310 are adopted to joint together as a triangle configuration is shown in FIGS. 5 and 6. This embodiment adopts three sides 310 to form a triangular shank 31.

Accompanying with FIG. 5, a corner point 311 is formed by a connection of any two sides 310. Herein, the plurality of corner points 311 correspondently disposed on the shank 31 are axially connected for constructing an imaginary line a that is herein parallel to a shank axis β in this embodiment. Further, a rib 312 is extended outwardly from each corner point 311 of the shank 31. The extending orientation of the rib 312 is cross-sectionally arranged in accordance with the drive-in direction of the screw 3 as arrowed in FIG. 5). Alternatively, the extending orientation of the ribs 312 is cross-sectionally arranged in accordance with the drive-out direction of the screw 3 as shown in FIG. 6. Herein, it is adopted that the extending orientation of the rib 312 is arranged toward the drive-in direction of the screw 3. Simultaneously, each rib 312 includes a cutting section 3121 extended outwardly from the corner point 311 about an arc contour, and a arc section 3122 whose two ends respectively connect to the cutting section 3121 and the side 310. Wherein, a cutting tip 3124 is formed at a convergence of the cutting section 3121 and the arc section 3122. Preferably, the cutting tip 3124 is arranged where a largest outer diameter of the shank 31 is defined. An accommodating room 3125 is defined between each arc section 3122 and the side 310. Favorably, the rib 312, as shown in FIG. 7, has a guiding section 3123 with both ends respectively connected to the corner point 311 and the cutting section 3121 for forming a debris-guiding room 3126 at a side of the guiding section 3123. The debris-guiding room 3126 and the accommodating room 3125 are communicated with each other. Herein, this embodiment adopts that the rib 312 has the guiding section 3123 as an example.

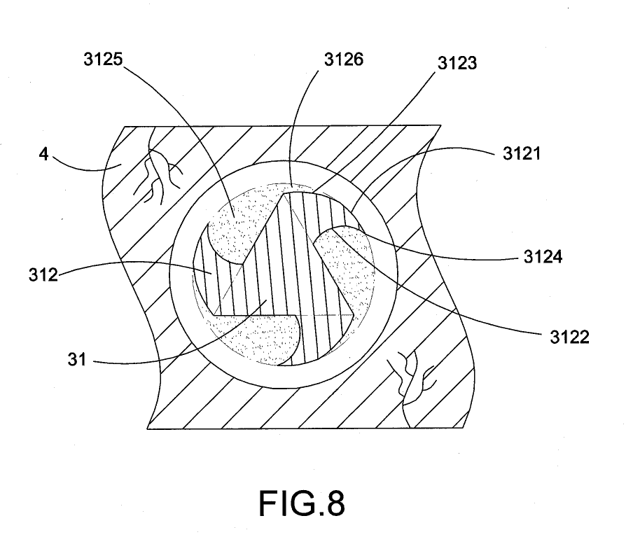

Referring to FIGS. 3 and 8, while driving the screw 3 into an workpiece 4 contained wood fibers, the screw 3 mainly utilizes the rib 312 to cut and sever the workpiece 4. Namely, the cutting tip 3124 and the cutting section 3121 cut the wood fiber so as to prevent the shank 31 from being entangled with the wood fiber, beneficial to a reduction in the cutting resistance. Furthermore, by means of the accommodating room 3125 derived from the arc section 3122 and the debris-guiding room 3126 derived from the guiding section 3123 capable of contacting with the workpiece 4 while drilling and cutting, the debris generated in time of cutting could be effectively expelled via the accommodating room 3125 and the debris-guiding room 3126, which thus prevents the workpiece 4 from being damaged incurred by the inferior debris guiding effect. Further, in time of drilling, the workpiece 4 merely contacts the cutting tip 3124 and the cutting section 3121, so the contacting area between the shank 31 and the workpiece 4 is obviously reduced, and the drilling resistance is preferably dwindled, which hence makes the driving torque reduced and the screwing speed enhanced. After drilling, the accommodating room 3125 and the debris-guiding room 3126 provide a large space for the large amount of debris to stay. As a result, the fixing effect of the present invention is evidently encouraged.

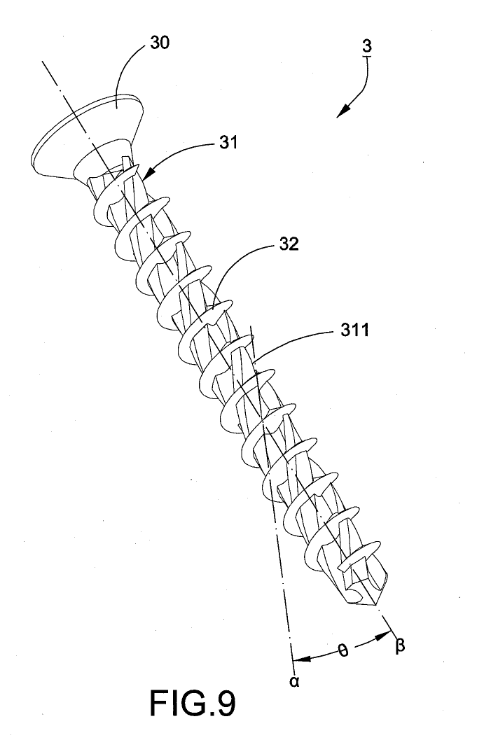

Referring to FIG. 9, a second preferred embodiment is shown. The screw 3 in accordance with the present invention comprises the similar elements, e.g. the head 30, the shank 31, and the threaded section 32, and provides the like efficacy as that of the first preferred embodiment. The analogous operation and effectiveness are herein omitted. Especially, the plurality of corner points 311 correspondently disposed on the shank 31 are axially connected to construct an imaginary line α that is inclined to the shank axis β by an inclination angle θ in this embodiment. Whereby, the screw 3 is able to gradually drive into the workpiece so as to provide a labor-saving and speedy operation.

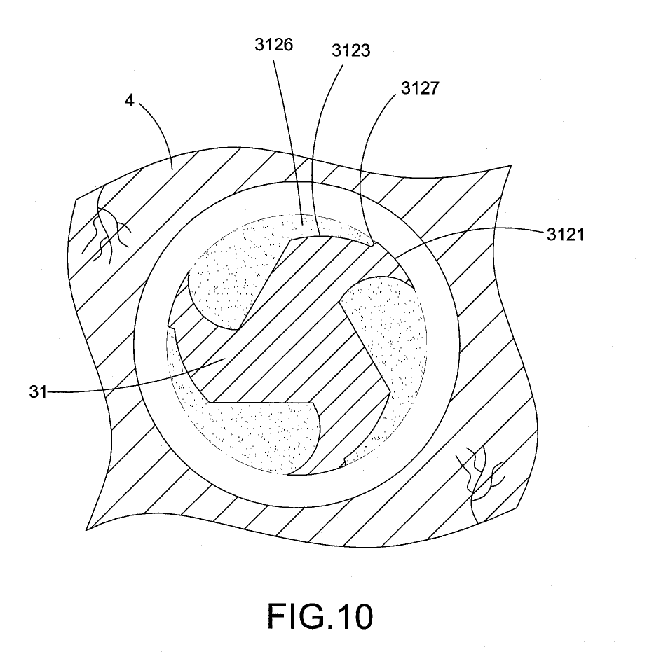

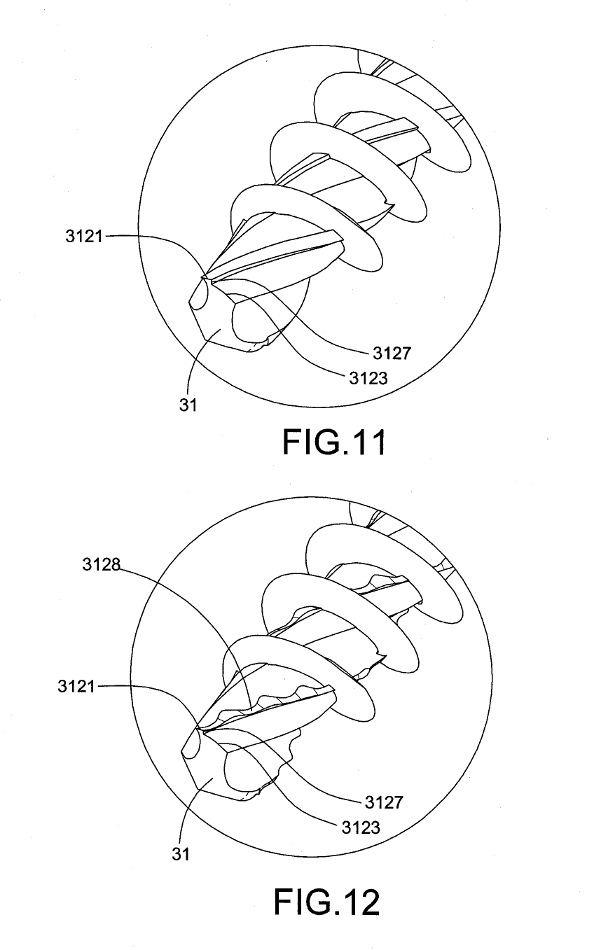

Referring to FIGS. 10 and 11, a third preferred embodiment of the present invention is shown. Different from the second embodiment, a debris-extruding section 3127 is arranged between the cutting section 3121 and the guiding section 3123 of the shank 31. Thereby, the debris-guiding room 3126 is enlarged. Moreover, a plurality of sunken slots 3128 are defined on the cutting section 3121. Preferably, the sunken slots 3128 could be defined at intervals or be consecutively connected; herein the figure, the sunken slots 3128 are connected with each other. Whereby, while driving the screw 3 into the workpiece 4, the debris-extruding section 3127 enlarges the space of the debris-guiding room 3126, so that the debris generated in time of cutting could be rapidly guided into the debris-guiding room 3126, in which more debris is allowed to save. The sunken slots 3128 not only reduces the contacting area between the cutting section 3121 and the workpiece 4 but also provides an extra space for extruding and receiving the debris. Thereby, the driving is less laborious but more speedy, and the fastening effect is more stable.

Referring to FIG. 13, a fourth preferred embodiment of the present invention is shown substantially alike the first preferred embodiment. Differently, at least one side 310 of the shank 31 is inwardly depressed. Such depressed side 310 is preferably suited to an iron workpiece (not shown) for achieving a stable fastening effect. Moreover, while each side 310 is inwardly depressed, a larger accommodating room 3125 between the arc section 3122 and the side 310 could be accordingly defined for timely extruding the debris so as to decrease the screwing resistance. Thereby, such screw 3 would not allow redundant debris to be adversely accumulated, which preferably prevents the screw 3 from breakage or avoids destroying the workpiece. Therefore, while the screw 3 is adopted to whichever of these workpieces, the iron workpiece and the wood workpiece with elastic fibers, the swift screwing and firm fastening effect are both attainable.

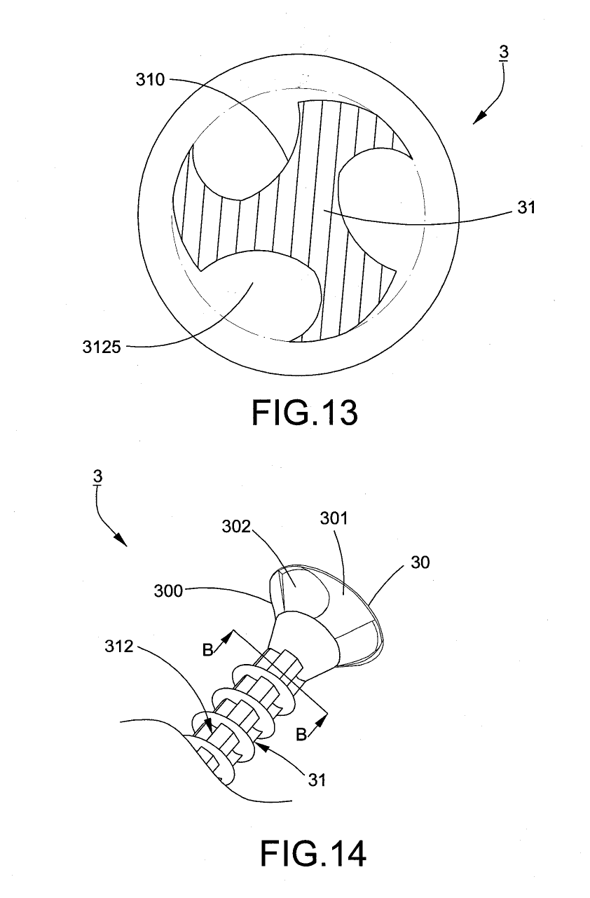

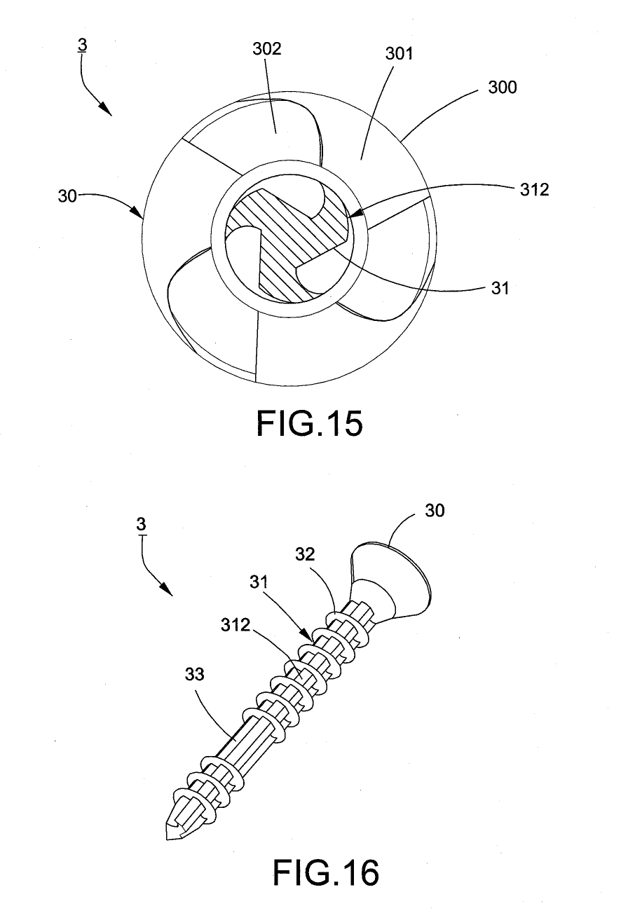

Referring to FIGS. 14 and 15, a fifth preferred embodiment of the present invention is shown substantially alike that of the first preferred embodiment. Differently, a plurality of cutting ribs 301 are arranged on the connecting surface 300 of the head 30 corresponding to rib 312 of the shank 31. Wherein, a cutting indentation 302 is defined between any two cutting ribs 301. When the connecting surface 300 touches the workpiece (not shown) to force the entry of the debris of the workpiece into a drilling hole, a height difference between the cutting indentation 302 and the cutting rib 301 is applied for leading to the debris firstly entering into the cutting indentation 302 during the drilling. Then the debris that are being extruded would be once again severed by the cutting rib 301. As a result, the flexible elasticity contained in the wood fibers would be substantially eliminated. After fastening, the present invention efficiently enhances the firmness of the screw 3 within the workpiece, and the screw 3 would not be easily retracted in view of the external factors, e.g. accidental vibrations.

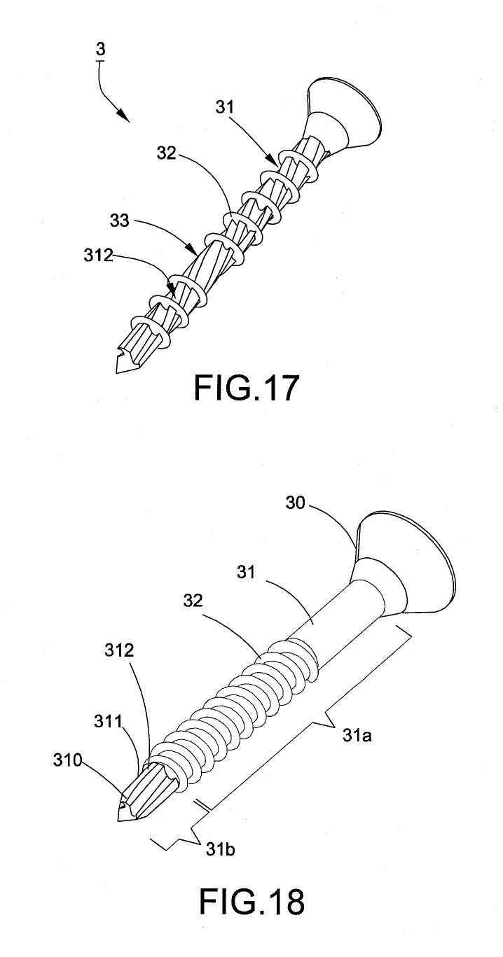

Referring to FIG. 16, a sixth preferred embodiment of the present invention is shown substantially alike that of the first preferred embodiment. Differently, a thread-free section 33 is formed among the threaded section 32 for accommodating the debris while cutting the workpiece. By means of the auxiliary ribs 312, which could be constructed either parallel (as shown in FIG. 16) or inclined (as shown in FIG. 17) with respect to the shank axis, a firm fastening effect and a promoted screwing speed during the cutting could be advantageously obtained.

Referring to FIG. 18, a seventh preferred embodiment of the present invention still comprises the head 30, the shank 31, and the threaded section 32. Differently, the shank 31 is divided into a first shank 31a and a second shank 31b. In this embodiment, the first shank 31a is constructed by a column, and the second shank 31b is constructed by at least two sides 310 (three sides 310 are adopted to form a triangular shank 31 in this embodiment). Moreover, the rib 312 is extended outwardly from the corner point 311. By means of the ribs 312 on the second shank 31b launching into the initial drilling, the threaded section 32 on the first shank 31a is able to promptly follow up for achieving a quick screwing and a stable fastening efficiency.

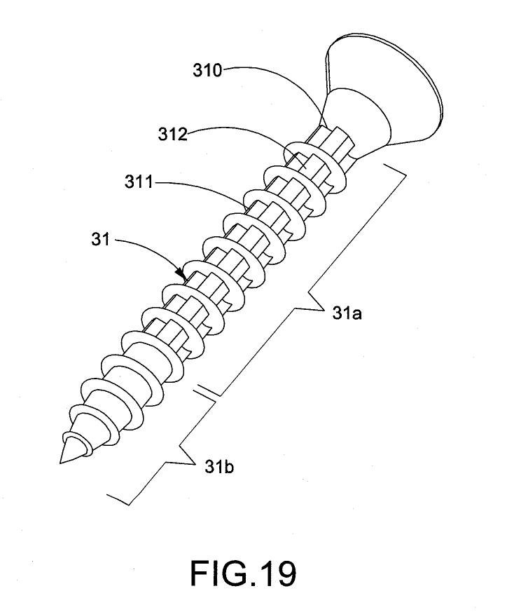

Referring to FIG. 19, an eighth preferred embodiment of the present invention is shown substantially alike that of the seventh preferred embodiment. Differently, the second shank 31b is constructed by a column, and the first shank 31a is constructed by at least two sides 310 (three sides 310 are adopted to form a triangular shank 31 in this embodiment). Moreover, the rib 312 is extended outwardly from on the corner point 311. Thus, no matter how the shank 31 varies in the configuration of the first shank 31a and the second shank 31b, the speedy and firm fastening efficacy could be still achieved.

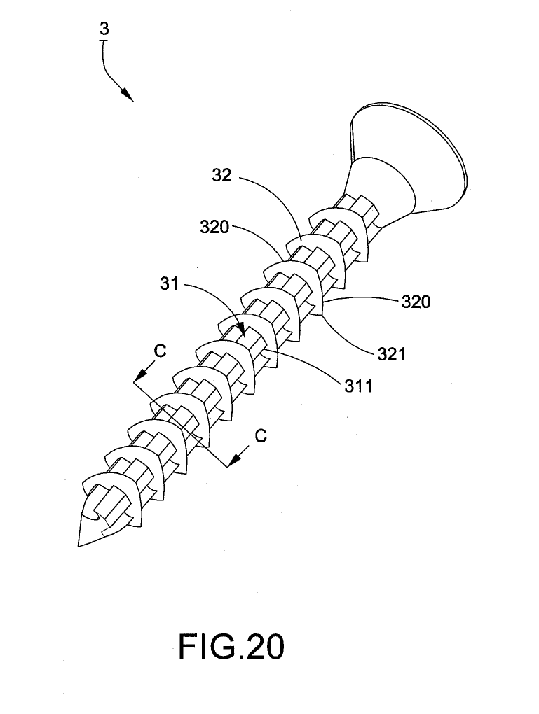

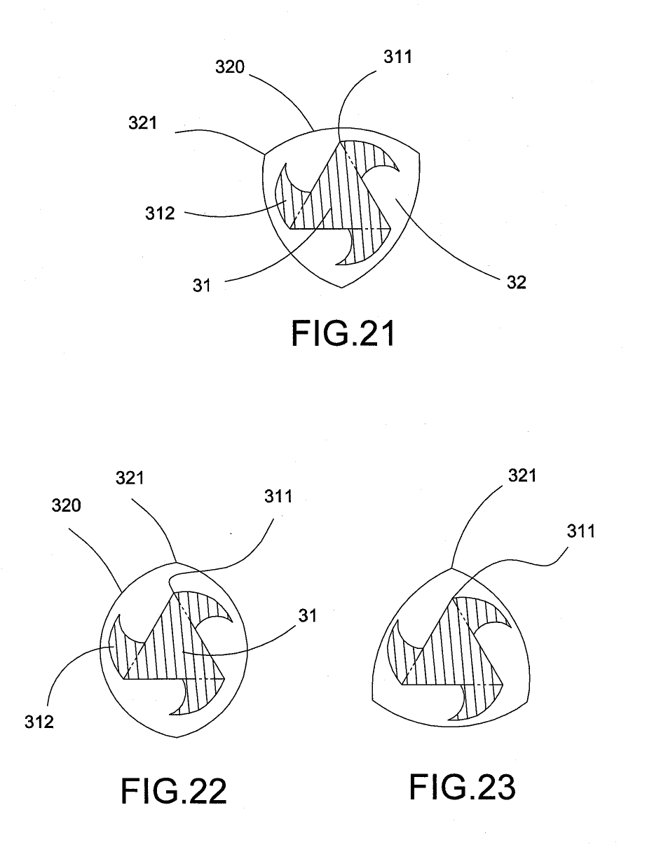

Referring to FIG. 20, a ninth preferred embodiment of the present invention is shown substantially alike that of the first preferred embodiment. Differently, the threaded section 32 is constructed by at least two cutting surfaces 320, for example, three cutting surfaces 320 are cross-sectionally presented in FIG. 21; or it may merely have two cutting surfaces 320 as shown in FIG. 22. Further, a cutting side 321 is formed at the convergence of any two cutting surfaces 320. As it permits, any of the corner point 311 of the shank 31 correspondently directs to the threaded section 32. That is, each corner point 311 of the shank 31 can be aimed at the corresponding cutting side 321 as shown in FIG. 21. Alternatively, each corner point 311 of the shank 31 is arranged correspondently directing to the cutting side 321 as shown in FIGS. 22 and 23. Thus, such cutting side 321 is especially suited to the iron workpiece because a large cutting strength could be provided. In the meantime, the rib 312 on the shank 31 further provides the auxiliary cutting and debris-extruding efficiency; the screw 3 is able to be swiftly driven into a designated location.

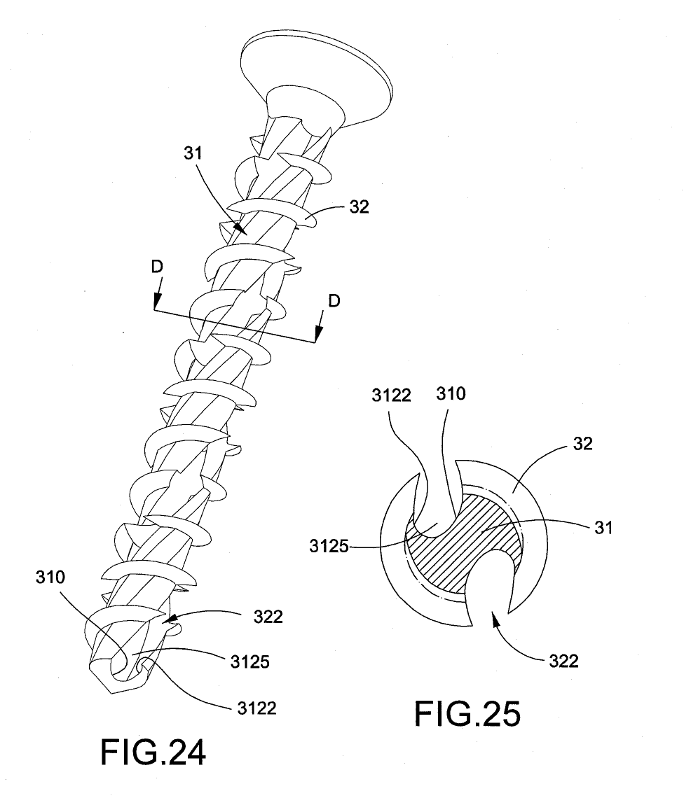

Referring to FIGS. 24 and 25, a tenth preferred embodiment of the present invention is shown substantially similar to that of the first preferred embodiment. Differently, a breach 322 that is disposed corresponding to the side 310 and the arc section 3122 is formed on the threaded section 32 side. Moreover, the side 310 is inwardly depressed toward the shank 31; herein, two sides 310 are adopted to joint together. In operation, the breach 322 communicates with the accommodating room 3125 of the shank 31, thereby permitting the debris accumulated on the threaded section 32 to be swiftly guided into the accommodating room 3125 via the breach 32. Thus, the debris would not be impeded by the threaded section 32, and a preferable debris-extruding effect is achieved.

To sum up, the present invention in particularly utilizes the shank with distinct structures and threaded section to achieve the favorable drilling efficiency, so that the screw could be applied to workpieces of different materials. Whereby, the present invention benefits to increase the using convenience, decrease the driving torque for a quick drilling and a less laborious operation, and attain the firm fastening effect.

While we have shown and described the embodiment in accordance with the present invention, it should be clear to those skilled in the art that further embodiments may be made without departing from the scope of the present invention.

I claim:

1. A drilling fastener comprises a head, a shank disposed on said head, and a threaded section spirally arranged on said shank; wherein, an inclined connecting surface being disposed between said head and said shank; at least two sides being formed on a periphery of said shank; a corner point being formed by a connection of any two sides;
wherein, a rib is extended outwardly from each corner point; each rib includes a cutting section extended outwardly from said corner point about an arc contour, and a arc section whose two ends respectively connect to said cutting section and said side; a cutting tip is formed at a convergence of said cutting section and said arc section; said cutting tip is arranged where a largest outer diameter of said shank being defined; an accommodating room being defined between each arc section and said side.

2. The drilling fastener as claimed in claim 1, wherein, a guiding section is connectively arranged between said corner point and said cutting section; a debris-guiding room is defined at a side of said guiding section; said debris-guiding room and said accommodating room are communicated with each other.

3. The drilling fastener as claimed in claim 1, wherein, a guiding section is disposed between said corner point and said cutting section; a plurality of sunken slots are disposed on said cutting section.

4. The drilling fastener as claimed in claim 1, wherein, a plurality of cutting ribs are disposed on said connecting surface, corresponding to said rib; a cutting indentation is formed between any two of said cutting ribs.

5. The drilling fastener as claimed in claim 2, wherein, a plurality of cutting ribs are disposed on said connecting surface, corresponding to said rib; a cutting indentation is formed between any two of said cutting ribs.

6. The drilling fastener as claimed in claim 1, wherein, at least one of said sides is inwardly depressed.

7. The drilling fastener as claimed in claim 2, wherein, at least one of said sides is inwardly depressed.

8. The drilling fastener as claimed in claim 1, wherein, said shank is divided into a first shank and a second shank; said first shank is constructed by a column, and said second shank is constructed by at least two sides; a corner point is disposed by a connection of any two of said sides; said rib is extended from said corner point.

9. The drilling fastener as claimed in claim 2, wherein, said shank is divided into a first shank and a second shank; said first shank is constructed by a column, and said second shank is constructed by at least two sides jointed together; a corner point is disposed by a connection of any of said two sides; said rib is extended from said corner point.

10. The drilling fastener as claimed in claim 1, wherein, said shank is formed by a first shank and a second shank; said first shank is constructed by at least two sides; a corner point is disposed by a connection of any two of said sides; said second shank is constructed by a column; said rib is extended from said corner point.

11. The drilling fastener as claimed in claim 2, wherein, said shank is formed by a first shank and a second shank; said first shank is constructed by at least two sides; a corner point is disposed by a connection of any two of said sides; said second shank is constructed by a column; said rib is extended from said corner point.

12. The drilling fastener as claimed in claim 1, wherein, a thread-free section is formed among said threaded section.

13. The drilling fastener as claimed in claim 2, wherein, a thread-free section is formed among said threaded section.

14. The drilling fastener as claimed in claim 1, wherein, said threaded section is formed by at least two cutting surfaces, and a cutting side is formed at a convergence of any two of said cutting surfaces; said corner point of said shank is correspondingly disposed to said cutting edge.

15. The drilling fastener as claimed in claim 2, wherein, said threaded section is formed by at least two cutting surfaces, and a cutting side is formed at a convergence of any of said two cutting surfaces; said corner point of said shank is correspondingly disposed to said cutting edge.

16. The drilling fastener as claimed in claim 1, wherein, said threaded section is formed by at least two cutting surfaces, and a cutting side is formed at a convergence of any of said two cutting surfaces; said corner point of said shank is correspondingly disposed to said cutting surface.

17. The drilling fastener as claimed in claim 2, wherein, said threaded section is formed by at least two cutting surfaces, and a cutting side is formed at a convergence of any of said two cutting surfaces; said corner point of said shank is correspondingly disposed to said cutting surface.

18. The drilling fastener as claimed in claim 1, wherein, said threaded section disposed with respect to said side and said arc section further includes a breach.

19. The drilling fastener as claimed in claim 2, wherein, said threaded section disposed with respect to said side and said arc section further includes a breach.
